(19) United States
(12) Patent Application Publication
(10) Pub. No.: US 2024/0119509 A1
(43) Pub. Date: Apr. 11, 2024

(54) OBJECT HIGHLIGHTING IN AN ECOMMERCE SHORT-FORM VIDEO

(71) Applicant: Loop Now Technologies, Inc., San Mateo, CA (US)

(72) Inventors: Edwin Chiu, Cupertino, CA (US); Shi Feng, Union City, CA (US); Michael A. Shoss, Milton (CA); Hong-Ming Tseng, Toronto (CA); Ziming Zhuang, Palo Alto, CA (US)

(73) Assignee: Loop Now Technologies, Inc., San Mateo, CA (US)

(21) Appl. No.: 18/376,481

(22) Filed: Oct. 4, 2023

Related U.S. Application Data
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.
(60) Provisional application No. 63/413,272, filed on Oct. 5, 2022.

(51) Int. Cl. G06Q 30/0601; G06F 3/01; G06Q 30/0207; G06T 11/60; G06V 10/764

(52) U.S. Cl. CPC G06Q 30/0633; G06F 3/013; G06Q 30/0222; G06Q 30/0623; G06Q 30/0643; G06T 11/60; G06V 10/764

(57) ABSTRACT

Techniques for object highlighting in an ecommerce short-form video are disclosed. The object highlighting can be associated with a product within the video, defining a highlighted product. The object highlighting can be performed automatically utilizing computer-implemented techniques. A short-form video from a library of short-form videos is accessed. A plurality of objects from a catalog of products featured in the short-form video is recognized. At least one of the plurality of objects displayed by a host is identified. A first object from the plurality of objects is selected. The first object is highlighted, which causes it to be surrounded by a boundary overlay in the short-form video. A representation of the first object is dynamically inserted into an on-screen product card. An ecommerce purchase of the first object is enabled within the short-form video.

### RELATED APPLICATIONS

This application claims the benefit of U.S. provisional patent applications “Object Highlighting In An Ecommerce Short-Form Video” Ser. No. 63/413,272, filed Oct. 5, 2022, “Dynamic Population Of Contextually Relevant Videos In An Ecommerce Environment” Ser. No. 63/414,604, filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, and “Livestream With Large Language Model Assist” Ser. No. 63/536,245, filed Sep. 1, 2023.

Each of the foregoing applications is hereby incorporated by reference in its entirety.

### FIELD OF ART

This application relates generally to short-form videos and more particularly to object highlighting in an ecommerce short-form video.

### BACKGROUND

Video, music, and other types of media files are encoded and transmitted in sequential packets of data so they can be streamed instantaneously. Thus, the term “streaming” can refer to any media content, live or previously recorded, that is delivered to computers and mobile devices via a network communication protocol and played back in real time. Podcasts, webcasts, movies, TV shows, and music videos are common forms of streaming content. Social media platforms and others broadcast everything from celebrity events, promotions, and livestreaming to streaming between users. Streaming video can be viewed on a variety of compatible smartphones, tablets, TVs, and/or computer or gaming consoles with a relatively fast internet connection. One type of streaming media is short-form videos. Short-form videos are gaining popularity. Individuals are now able to consume short-form videos from almost anywhere on any connected device at home, at work, or even walking outside. Especially on mobile devices, social media platforms have become an extremely common use of internet-based video. Accessed through the use of a browser or specialized app that can be downloaded, these platforms include various services. While these services vary in their video capabilities, they are generally able to display short video clips, repeating video “loops”, livestreams, music videos, etc. These videos can last anywhere from a few seconds to several minutes or longer. Short-form videos cover a variety of topics. Important subcategories of short-form videos include livestreams and livestream replays. Countless hours are spent online watching an endless supply of videos from friends, family, social media “influencers”, gamers, favorite sports teams, or from a plethora of other sources.

Utilizing short-form videos as part of a product promotion strategy allows engagement with audiences that typically ignore text and banner ads. Marketers are allocating more of their advertising budget to video ads in order to gain a competitive advantage. Getting someone to click on a static display ad means impressing them enough with a single appealing image or headline. Video advertising, on the other hand, includes more elements users may find relevant or engaging. Video advertisements may use a catchy song, a funny opening line, or a relatable situation to get viewers hooked and urge them to watch the advertisement in its entirety. The rise of technologies and services, which have enabled video, have led to a new level of engagement. Nowadays, users consume a vast amount of video online. Additionally, users are now able to easily comment on, share, and otherwise engage with short-form videos as promotional tools. As technologies improve and new services are enabled, the proliferation of short-form videos will continue.

### SUMMARY

Personal electronic devices such as mobile devices can be used to access information of many types on the Internet. The electronic devices, which can include desktop computers, laptop computers, and personal electronic devices such as tablets, smartphones, and PDAs, are widely used by people who want to observe and interact with content such as product information. The product information can be presented as a short-form video stream. The video streams can include livestreams in which an individual or team of individuals can share thoughts and comments, present goods and services, and so on. Short-form videos, including livestream videos, can be generated on a wide variety of electronic devices including smartphones, tablet computing devices, televisions, laptop computers, desktop computers, digital video cameras, and more. Livestream videos are becoming more and more relevant for the dissemination of information and entertainment. The information can include news and weather information, sports highlights, product information, reviews of products and services, product promotion, educational material, how-to videos, advertising, and more. Generation of livestream videos is therefore taking on a new importance in light of these trends.

Livestream videos can be used for product demonstrations. A host individual is a person who may discuss multiple products during the course of a livestream video. The products can be offered from a single vendor, or from a variety of vendors. The products offered from a variety of vendors may all be related (e.g., automotive products). Some videos may include multiple host individuals operating as a team to discuss one or more products. As the host begins discussing, using, or otherwise interacting with a given product (object), the product is detected by computer-implemented techniques and a highlight indication is rendered in the manipulated video. The highlight indication can be generated, or rendered, based on the actions and/or spoken words of the host individual, and/or other criteria. The highlight indication can be a static image such as a graphic illustration which is overlaid on the object, surrounds the object, or is placed adjacent to the object, and/or can additionally include overlaid text, and/or photographs. The highlight indication can be a dynamically changing image such as an animation, video clip, animated GIF, and/or other dynamically changing image. The highlight indications can be created a priori, or can be defined and/or selected to correspond to the product currently being discussed by a host individual. The defining can include the size and/or color of the highlight indication. The highlight indication can be defined and/or selected based on information in an audio track associated with the livestream video. In embodiments, the highlight indication can be defined and/or selected based on machine learning. Supervised and/or unsupervised learning can be used for defining and/or placing of highlight indications utilizing artificial intelligence, neural networks, deep learning, and/or other suitable techniques.

A product within a video can have a highlight indication associated with it, thereby becoming a “highlighted product”. The highlight indication can be a boundary overlay. A viewer can click on a highlighted product within the video to purchase the product. A viewer also can click on a product within the video to obtain further information about the product, a good, a service, etc. Selecting the product within the video can add the product to a virtual purchase cart associated with the user. A product that is selected by a viewer can be placed into a virtual purchase cart. The virtual purchase cart can include a virtual shopping cart, a virtual shopping bag, and the like. The user can check out using the virtual purchase cart. The checking out can accomplish purchasing the contents of the cart.

A computer-implemented method for video analysis is disclosed comprising: accessing a short-form video from a library of short-form videos; recognizing a plurality of objects from a catalog of products featured in the short-form video; identifying when a host is displaying at least one of the plurality of objects, based on the recognizing; selecting, using one or more processors, a first object from the plurality of objects, wherein the selecting is based on the identifying; highlighting the first object in the short-form video, wherein the highlighting causes the first object to be surrounded by a boundary overlay in the short-form video; inserting a representation of the first object into an on-screen product card, wherein the inserting is accomplished dynamically; and enabling an ecommerce purchase of the first object, wherein the ecommerce purchase is accomplished within the short-form video. In embodiments, the selecting is further based on audio analysis. In embodiments, the selecting is further based on gaze detection. Some embodiments comprise revealing details of the first object based on a first user action with the on-screen product card or the boundary overlay.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for object highlighting in an ecommerce short-form video.

FIG. 2 is a flow diagram for recognizing objects with machine learning training and completing a purchase.

FIG. 3 is an infographic for object detection within an ecommerce short-form video.

FIG. 4A is an example illustrating timing of object highlighting in an ecommerce short-form video.

FIG. 4B is another example illustrating timing of object highlighting in an ecommerce short-form video.

FIG. 5 is a block diagram for machine model training and use.

FIG. 6A is an infographic showing real-time auction usage within an ecommerce short-form video.

FIG. 6B is an infographic showing real-time auction usage within an ecommerce short-form video after making a selection.

FIG. 7 is a system block diagram illustrating virtual purchase cart operation.

FIG. 8 is a system diagram for object highlighting in an ecommerce short-form video.

### DETAILED DESCRIPTION

Techniques for object highlighting in an ecommerce short-form video are disclosed. The object highlighting can be associated with a product within the video, defining a highlighted product. The object highlighting can be performed automatically utilizing computer-implemented techniques. When a viewer of the video interacts with the highlighted video, disclosed embodiments present additional product information and/or a user interface that enables purchase of the product via a virtual purchase cart. By creating highlighting, objects can be emphasized, making the short-form video more engaging and interesting to viewers. The objective of the short-form video will be clearer, and the ecommerce orientation will have more focus.

In embodiments, objects are highlighted at a specific temporal point within a video. The temporal point can include an instance in time when the product is being featured within a video. The temporal point can be determined based on actions of a host individual. The actions can include the host individual looking toward the product for a predetermined time interval, touching the product, moving the product, and/or performing other actions.

The identification of products within a video can be based on machine learning, pattern recognition, and/or optical identifiers. The optical identifiers can include information on product labels. The information can include barcodes, text, images, and/or other optical patterns imprinted or rendered on the product. In embodiments, the identification of products is performed automatically, and a highlight indication is generated and rendered on the video. The highlight indication can track the motion of the associated product or object as it is moved within the video. In some embodiments, multiple highlight indications can be simultaneously rendered in a video. This can occur, for example, when multiple products are being featured, compared, or otherwise discussed concurrently.

The object highlighting can include various forms. In some embodiments, the object highlighting can include drawing a closed shape, such as a rectangle or oval, around an object. The object highlighting can include applying a translucent mask over the video, where the portion of the mask over and/or adjacent to the object is lighter than the rest of the mask, creating a “spotlight” effect. The object highlighting can include rendering a graphic element such as an icon. In some embodiments, the icon can include an arrow pointing to the object. Further, text can be included in addition to, or instead of, the icon. The text can include instructions which prompt the viewer of a video to interact with the highlighted object.

In embodiments, the viewer of the video interacts with the highlighted object by selecting the object. The selecting can include placing a mouse cursor over the object and clicking on the object. In some embodiments, the selecting can include mousing over the object (placing the cursor over the object without any mouse clicking). Further, some embodiments utilize a touchscreen, and the selecting can include tapping, double tapping, and/or swiping the object with a finger of the viewer, stylus, or using some other suitable technique. In some embodiments, the selecting can include eye gaze of the viewer of the video directed at the highlighted object for a predetermined duration. The selecting can be based on voice recognition. In some embodiments, once an object is highlighted, a user can utter a phrase, such as “show me more” to perform an interaction with the highlighted object.

The identification of an object to highlight can be based on user input. As an example, a host individual within a short-form video may be discussing a blender. A viewer of the video may be watching, and may take note of the shirt that the host individual is wearing. The viewer of the video can be interested in learning more about the shirt that the host individual is wearing, even though the main topic of the video is a blender and not the shirt that the host individual is wearing. In embodiments, the user can select (e.g., using a mouse cursor, fingers on a touchscreen, or the like) a region of the video that includes the shirt of the host individual. This causes disclosed embodiments to perform an object analysis within that region. A shirt can be identified within that region. The shirt can be compared to an existing database of shirts, and if identified, product information associated with the shirt is presented to the viewer of the video. While a shirt is used in the aforementioned example, disclosed embodiments can perform similar actions with many other objects that can be identified utilizing computer-implemented techniques.

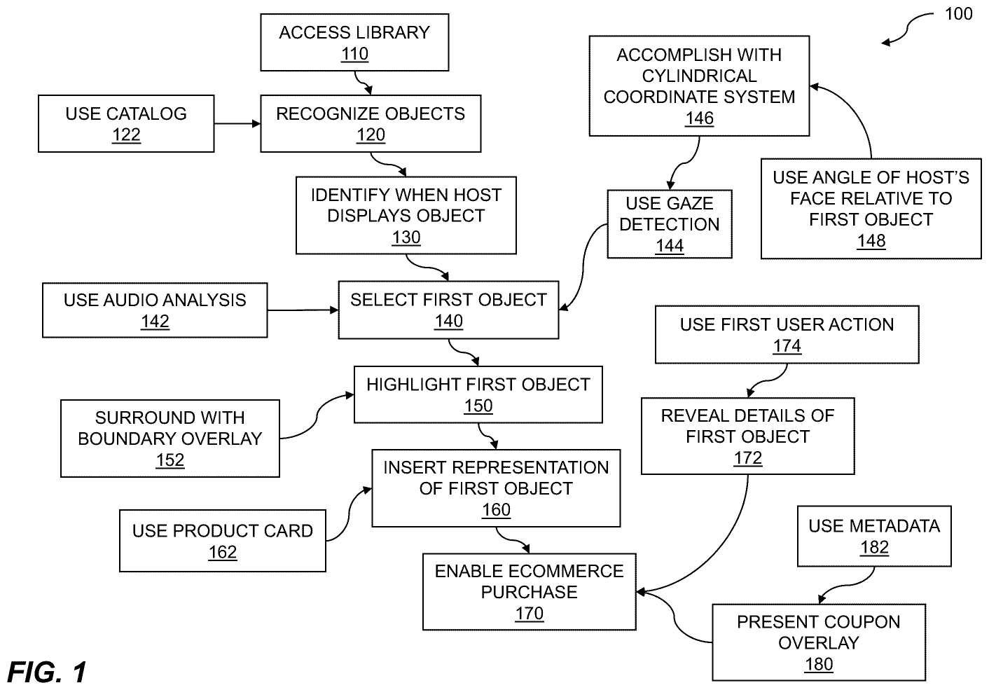

FIG. 1 is a flow diagram 100 for object highlighting in an ecommerce short-form video. The flow includes accessing a library 110. The library can include a library of short-form videos. The short-form videos can be ecommerce short-form videos. The short-form videos can be produced by popular content creators such as “influencers” that have many followers. The accessing of the short-form video library can be accomplished via any suitable network protocol, including, but not limited to, TCP, UDP, HTTP Live Streaming (HLS), Real-Time Messaging Protocol (RTMP), Web Real-Time Communications (WebRTC), Secure Reliable Transport (SRT), and/or other suitable protocols. The video can be delivered via unicast, multicast, or broadcast. In many cases, multicast is considered a one-to-many and many-to-many communication protocol that reduces network traffic when transmitting large amounts of data. Bandwidth optimization can occur because it delivers one single version of a data file, such as a livestream video, to hundreds or thousands of users simultaneously.

The short-form videos can be stored in a networked database. The flow includes recognizing objects 120 within the short-form videos. In embodiments, the recognizing is performed via machine learning, image classifiers, neural networks, and/or other artificial intelligence techniques for object identification within a video. The flow can include using a catalog 122. The catalog can include information regarding multiple products. The information can include images, product specifications, pricing, availability, links to ecommerce sites associated with products, and/or other suitable information. In some embodiments, the catalog can be used as training data for a machine learning system.

The flow includes identifying when a host displays an object 130. The identifying can include rendering a graphic overlay, such as a rectangle or oval, around the object. In embodiments, the identifying can further include a sound effect that coincides with the rendering of the graphic overlay. As an example, when an object is identified, a graphic overlay of a rectangle around the object is rendered, and an audio sample of a chime sound is concurrently mixed into the associated audio for the video. In this way, the viewer of the video hears a chime as the graphic overlay is rendered. This causes two senses (hearing and sight) to be stimulated, increasing the likelihood that the viewer of the video notices that an object has been highlighted within the short-form video.

In embodiments, the selecting is further based on audio analysis. In embodiments, the selecting is further based on gaze detection. The gaze detection is accomplished with a cylindrical coordinate system. In embodiments, the gaze detection includes an angle of the host's face relative to the first object in the short-form video. The enabling further comprises revealing details of the first object based on a first user action with the on-screen product card or the boundary overlay. Embodiments can include presenting a coupon overlay to the user. A coupon overlay can be revealed to the user after watching the short-form video for a period of time. In some embodiments, presenting the coupon is based on metadata. In some embodiments, the identifying of the object for which the coupon is revealed is independent of physical motions of the host or location of the first object in the short-form video. In embodiments, metadata for the boundary overlay is recorded with the short-form video.

The flow can include selecting a first object 140. In embodiments, the object can be selected using audio analysis and/or gaze detection. The object can be a product that is being demonstrated and/or discussed in an ecommerce short-form video. The product can be a kitchen appliance, article of clothing, tool, book, personal electronic device, and/or any other suitable type of product.

The flow can include using audio analysis 142. The audio analysis can include natural language processing, entity detection, disambiguation, and/or other techniques to determine an object being discussed within a short-form video. The audio analysis can include digitizing speech via an analog-to-digital converter and performing filtering and segmentation into audio chunks that are matched to phonemes in a given language, such as English. The sequence of phonemes may then be input to a machine learning system or other mathematical model to compare them to well-known sentences, words, and phrases and then to determine the most likely meaning of verbal utterances.

The flow can include using gaze detection 144. The gaze detection can include determining where a host individual is looking, and for how long. In embodiments, when a host individual gazes at an object for a predetermined duration (e.g., three seconds), the object can be selected for highlighting. In embodiments, the gaze detection comprises a multilevel process that includes detecting human faces, detecting eyes within the human faces, and detecting pupils within the detected eyes. Embodiments can utilize one or more image classifiers, such as Haar Cascade face and eye classifiers, to perform this identification. The flow can include using a cylindrical coordinate system 146. A cylindrical coordinate system is a three-dimensional coordinate system that specifies points by a radial distance d, angular coordinate w, and height z. The three pieces of data make up a tuple (d, w, z) that can be used to represent a point in space. A cylindrical coordinate system is well suited for use in gaze determination since a human torso can be approximated as being bounded by a cylindrical shape. The flow can include using an angle of a host individual's face relative to a first object 148. In embodiments, when the value of the determined angle is in a range that is indicative of looking toward the first object for a predetermined period of time, the first object can be highlighted.

The flow includes highlighting a first object 150. The highlighting can include surrounding the object with a boundary overlay 152. The boundary overlay can be in the shape of a rectangle, oval, or another suitable shape to surround the object. The boundary overlay can be opaque in some embodiments. In some embodiments, the boundary overlay can have a level of transparency, via an alpha-blending value. Further, a sound sample is played concurrently with the rendering of the boundary overlay, to further draw attention to the highlighted object (product).

The flow further includes inserting a representation of the first object 160. The flow can include using a product card 162. Embodiments can include inserting a representation of the first object into an on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an additional on-screen display is rendered over a portion of the video while the video continues to play. This enables a user to purchase a product/service while preserving a continuous video playback session. In other words, the user is not redirected to another site or portal that causes the video playback to stop. Thus, users are able to initiate and complete a purchase completely inside of the video playback user interface, without being directed away from the currently playing video. Allowing the video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The flow can include enabling an ecommerce purchase 170, wherein the ecommerce purchase is accomplished within the short-form video. The enabling can include rendering a product card associated with the product. The enabling can include revealing a virtual purchase cart that supports checkout, including specifying various payment methods, and application of coupons and/or promotional codes. In some embodiments, the payment methods can include fiat currencies such as United States Dollar (USD), as well as virtual currencies, including cryptocurrencies such as Bitcoin. In some embodiments, more than one object (product) can be highlighted and enabled for ecommerce purchase. In embodiments, when multiple items are purchased via product cards during the playback of a short-form video, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

The flow can include revealing details of the first object 172. The details can include, but are not limited to, price, shipping cost, vendor name, manufacturer name, and other item descriptions. The flow can include using a first user action 174 as a criterion for revealing details of the first object. The first user action can include selecting of the object via a mouse cursor, touchscreen operation (e.g., tap, swipe, double tap, etc.), speech recognition (e.g., saying a phrase when the object is highlighted), eye tracking (gazing at the highlighted object for a predetermined period), gestures, or other suitable techniques.

The flow can include presenting a coupon overlay 180 to the viewer of the video. The coupon overlay can include a quick response (QR) code, barcode, alphanumeric code, or other suitable indicia. In this way, product demonstrations and/or promotions within livestreams, livestream replays, and/or other short-form videos are enhanced. The flow can include using metadata 182 for presenting the coupon overlay. The metadata can include hashtags, repost velocity, user attributes, user history, ranking, product purchase history, view history, host identity, host attributes, or user actions. The user actions can include, but are not limited to, zoom, volume increase, number of times the video is paused, duration of time that the video is paused, number of replays, number of reposts, number of likes, comments, or clicks on advertisements. The user actions can further include purchase history and purchase percentage (the percentage of time the user makes a purchase during the watching of a short-form video). In some embodiments, a purchase percentage in a predetermined range is used as a criterion for presenting a coupon overlay. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

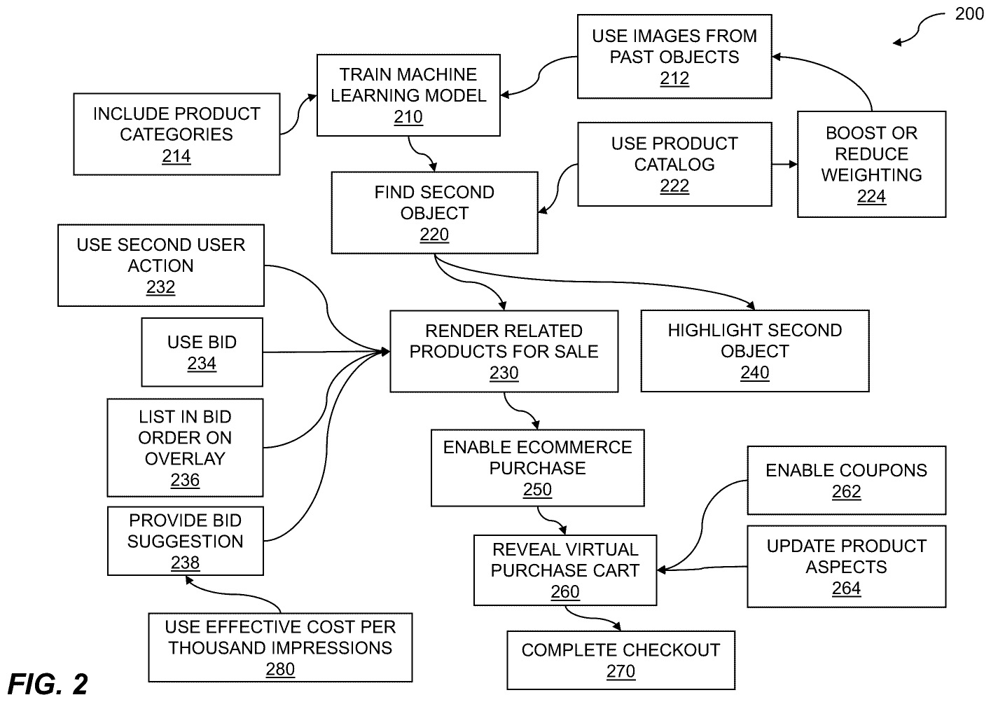

FIG. 2 is a flow diagram 200 for recognizing objects with machine learning training and completing a purchase. The flow can include training a machine learning model 210. The machine learning model can include, but is not limited to, a binary classification model, a multiclass classification model, and/or a regression model. The training can include supervised learning, unsupervised learning, semi-supervised learning, and/or reinforcement learning.

The flow can include product categories 214. In embodiments, the product categories can be provided a priori. Categories can include, but are not limited to, apparel, domestics, electronics and accessories, food and beverages, footwear, health and beauty, infant products, publishing, sporting goods, stationery, toys and games, and/or other categories that can be demonstrated and/or promoted using ecommerce short-form videos. The categories can be used for training the machine learning models. The flow can include using images from past objects 212. In embodiments, the past objects are objects that were previously presented and/or discussed in an ecommerce short-form video. The past objects can be used for training the machine learning model. The flow can include using a product catalog 222. The product catalog can include descriptions of one or more items. The descriptions can include various pieces of metadata for each item. In embodiments, a weighting is derived for each item, based on metadata in the product catalog. The flow can include boosting or reducing weighting 224. The boosting or reducing can be used to fine tune the training of the machine learning model. In some embodiments, the reducing of weighting can be based on the age of the entry in the product catalog. That is, entries that have not been updated in a while can have a reduced weight, whereas more recent entries can have a boosted weight. In other embodiments, popular selling items can have a boosted weight, whereas items that have lower sales can have a reduced weight. The boosting and reducing of weights can be used to enhance the training of the machine learning model.

The flow can include finding a second object 220. In embodiments, the finding of the second object can be performed via machine learning, image classifiers, neural networks, and/or other artificial intelligence techniques for object identification within a video. The flow can include highlighting the second object 240. In embodiments, object highlighting can include drawing a closed shape, such as a rectangle or oval, around an object. In some embodiments, the object highlighting can include applying a translucent mask over the video, where the portion of the mask over and/or adjacent to the object is lighter than the rest of the mask, creating a “spotlight” effect. In some embodiments, the highlighting of the second object can occur sequentially. That is, a first object is highlighted, and then a second object is highlighted while the first object becomes unhighlighted. As an example, this can occur during an ecommerce short-form video when a host individual stops discussing/presenting a first object (product), and begins to discuss a second object (product). In some embodiments, the second object can be highlighted concurrently with the first object. As an example, this can occur during an ecommerce short-form video when a host individual discusses two objects (products) concurrently, for demonstration, compares the two products, or promotes a collection of products. In some embodiments, the highlighting of the first object and highlighting of the second object can be similar. In other embodiments, the highlighting of the first object can have differences with the highlighting of the second object. For example, the first object can be highlighted in a first color (e.g., green), and the second object can be highlighted in a second color (e.g., orange). In further embodiments, the first object can be highlighted in a first shape (e.g., rectangle), and the second object can be highlighted in a second shape (e.g., oval).

The flow can include rendering related products for sale 230. In embodiments, the related products are selected from the product catalog. The flow can include using a second user action 232. In embodiments, the related products are rendered for sale based on the second user action. In some embodiments, the second user action can include selecting a region of the short-form video via a mouse cursor; a touchscreen action such as a swipe, tap, or circling of a region; a verbal utterance; or an eye gaze directed to a particular region of the ecommerce short-form video. The flow can include providing a bid suggestion 238. The flow can include using effective cost per thousand impressions 280. In embodiments, the bid suggestion includes a suggested bid price, where the suggested bid price is based on the effective cost per thousand impressions (eCPMs). In embodiments, the eCPM is computed by dividing advertising revenue by total impressions, and multiplying by one thousand. The eCPM provides a metric that can be used to calculate the value of future impressions, and thus, can be used to generate a reasonable bid price for an advertisement.

The flow can include using the bid 234 as a criterion for how related products are rendered for sale. In embodiments, vendors can bid on the advertisements and/or product cards, such that a given advertisement and/or product card can be selected to appear in an ecommerce short-form video, such as a livestream or livestream replay. In embodiments, the auctioning can be implemented via an online marketplace or other suitable ecommerce system. A variety of auction types can be utilized for auctioning the placement of an advertisement and/or product card. In some embodiments, an absolute auction, in which the highest bid wins regardless of price, is used. Other embodiments utilize a minimum bid auction, in which there is a minimum bid amount required before there can be a sale of an advertisement placement (insertion opportunity). Other embodiments utilize a reserve auction, in which the seller can accept, reject, or counter the winning bid. Still other embodiments utilize a Dutch auction, in which the bidding for an advertisement placement starts at a very high price and is progressively lowered until a buyer claims the advertisement placement. A variety of other auction types can be used. The flow can include listing multiple rendered products for sale, in bid order, on the overlay 236.

The flow includes enabling an ecommerce purchase 250. The enabling can include rendering a product card associated with the product. The enabling can include revealing a virtual purchase cart that supports checkout, including specifying various payment methods and application of coupons and/or promotional codes. Products can be added to the virtual purchase cart for later purchase. In some embodiments, the payment methods can include fiat currencies such as USD, as well as virtual currencies, including cryptocurrencies such as Bitcoin. The flow includes revealing a virtual purchase cart 260. In embodiments, the virtual purchase cart can invoke a virtual shopping cart, a virtual shopping bag, a virtual tote, etc. A representation of the virtual purchase cart can be displayed while the viewer is viewing the short-form video. In embodiments, the virtual purchase cart is checked out upon termination of the short-form video. The termination can be based on the video streaming being terminated at the source, the user terminating the video streaming at the destination, and/or\ an ending of a recorded video. Multiple purchases can be processed simultaneously upon termination of the short-form video in a batch order process, thereby saving computer resources such as network bandwidth.

The flow can include enabling coupons 262. The coupons can include a quick response (QR) code, barcode, alphanumeric code, or other suitable indicia. In this way, product demonstrations and/or promotions within livestreams, livestream replays, and/or other short-form videos are enhanced. In embodiments, the coupon can be a dynamically decrementing coupon. The dynamically decrementing coupon is presented at a temporal point within an ecommerce video at a predetermined initial value. The initial value is then decremented per given duration of play of the ecommerce short-form video. As an example, at a time of 2:00 (two minutes) within an ecommerce short-form video, a coupon for a ten percent discount on a product is rendered. Every thirty seconds, the coupon value is decremented. Thus, continuing with the example, at a time of 2:30 (two minutes and thirty seconds within the ecommerce short-form video), the coupon value is decremented from ten percent to nine percent (or some other lower value). Then at 3:00, the coupon value is decremented again from nine percent to eight percent. In some embodiments, the decrementing can be linear. In other embodiments, the decrementing can be non-linear. The dynamically decrementing coupon can be used to encourage viewers to make a purchase earlier within the ecommerce short-form video in order to take advantage of the larger coupon discount.

Embodiments can include training a machine learning model to recognize the plurality of objects from the catalog of products featured in the short-form video. In embodiments, the training includes images from past objects, product catalogs, short-form videos, keywords, or transfer learning. In embodiments, the training includes boosting or reducing weighting of images, wherein the boosting or reducing is based on the catalog of products. In embodiments, the training includes product categories that appear in the short-form video. Embodiments can include finding a second object from the plurality of objects. In embodiments, the highlighting includes the second object in the short-form video. Embodiments can include rendering one or more products for sale related to the second object, wherein the rendering is enabled by a second user action. In some embodiments, the rendering one or more products for sale is based on a bid from an advertiser. Embodiments can include providing a bid suggestion, to the advertiser, based on effective cost per thousand impressions (eCPMs). In embodiments, the rendering one or more products for sale is listed in order of highest bid to lower bid as an overlay on the short-form video. The enabling includes an ability for a user to clip coupons.

The flow can include updating product aspects 264. In embodiments the aspects can include size, color, quantity, and/or other product aspects. The flow includes completing checkout 270. The completion of checkout can include specifying shipping information, such as address and shipping method. The completion of checkout can include specifying a payment method. In embodiments, a user can pre-register prior to viewing the video, allowing the virtual purchase cart associated with the viewer to be enabled, and retrieving previously entered customer information. This in turn allows the viewer to check out items within their virtual purchase cart using a “one-click” technique. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

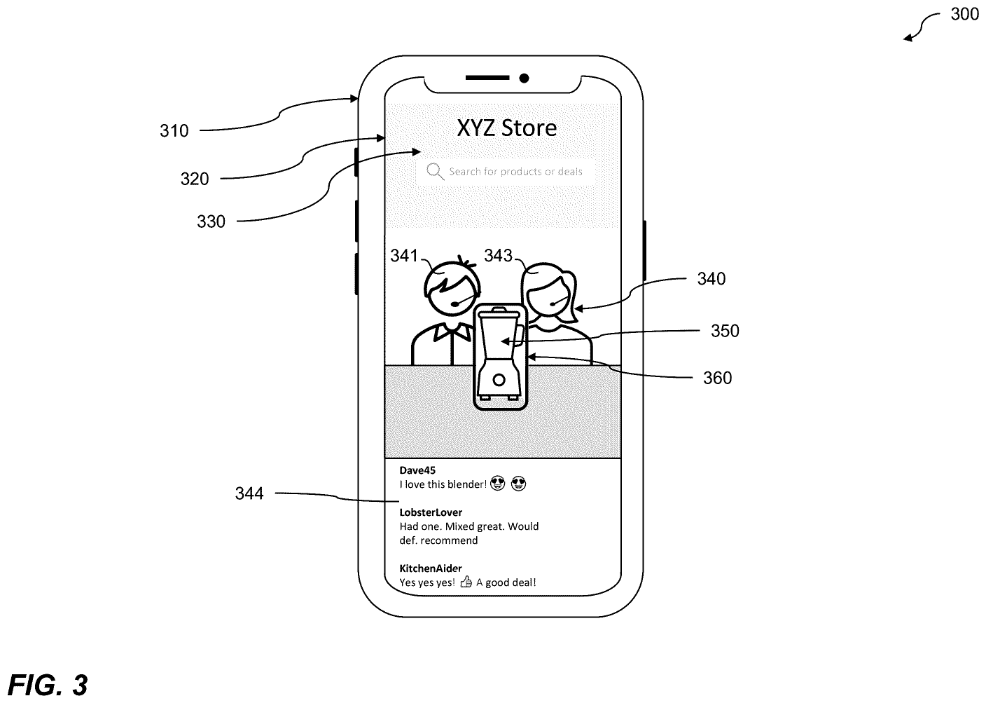

FIG. 3 is an infographic 300 for object detection within an ecommerce short-form video. An electronic computing device 310 includes an electronic display 320. The device can include a handheld device such as a smartphone, PDA, or tablet; a portable device such as a laptop computer; a desktop computer; and so on. The electronic display can support an app such as a video player, web browser, and so on that can render content which can include a video stream delivered from a server. The electronic display can also be a touchscreen to enable a user interface. An application, such as an HTML, browser or other special purpose application 330, executes on the electronic computing device 310. A video region 340 can display a short-form video. The short-form video can include one or more host individuals, indicated as 341 and 343, who may discuss one or more products during the course of the short-form video. In embodiments, the short-form video comprises a livestream video or livestream video replay. While two host individuals are shown in the example 300, other embodiments may utilize more or fewer host individuals.

In the example 300, a product 350 is being discussed by the host individuals 341 and 343. In this example, the product 350 is a blender. As the host individuals 341 and/or 343 interact with the product 350, a highlight indication 360 is rendered, based on techniques such as gaze detection; natural language processing; a host individual holding, touching, and/or moving the product; and/or other aforementioned techniques. In embodiments, the highlight indication 360 can be a boundary overlay that surrounds a product, such as is illustrated in FIG. 3, where highlight indication 360 surrounds product 350. Note that the product 350 can comprise a product picture, a product video, a product representation, a product drawing, a product abstraction, a product three-dimensional rendering, and so on. A user can select the highlighted indication by a tap, click, mouse-over, gesture, verbal utterance, eye gaze, or other suitable technique. The application 330 can further include a chat window 344. The chat window can include comments and questions from viewers of the short-form video shown in the video region 340. This can enable additional engagement with the ecommerce short-form video.

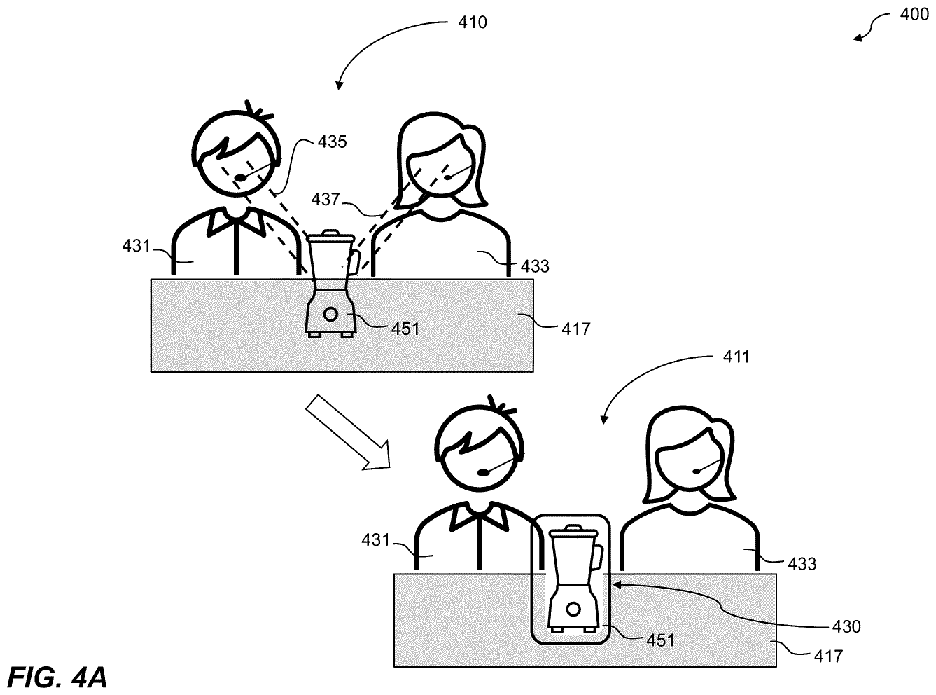

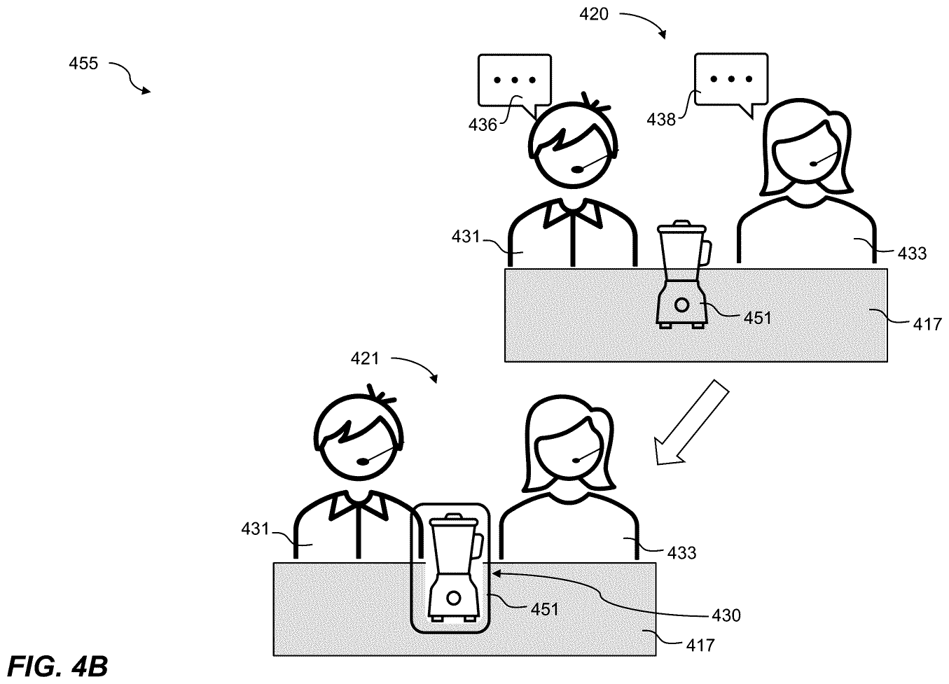

FIG. 4A is an example 400 illustrating the timing of object highlighting in an ecommerce short-form video. A first temporal point of an ecommerce short-form video is indicated at 410. A first host individual 431 and a second host individual 433 are behind a countertop 417 on which a product 451 is placed. During the course of the ecommerce short-form video, the eye gaze 435 of host individual 431 is computed as being directed toward product 451. Similarly, the eye gaze 437 of host individual 433 is also computed as being directed toward product 451. In some embodiments, when all host individuals within the ecommerce short-form video have directed their gaze on the product for a predetermined time period (e.g., three seconds), the product is then highlighted.

A second temporal point of the ecommerce short-form video is indicated at 411. The temporal point indicated by 411 is later than the temporal point indicated by 410. Thus, at some later point in the ecommerce short-form video, a highlight indication 430 for product 451 is rendered. In some embodiments, the highlight indication 430 is selectable by a viewer to obtain further information on the product 451, and/or to enable ecommerce purchase of the product 451. In some embodiments, the highlighting of the product is performed concurrently with rendering a product card corresponding to the product.

FIG. 4B is another example 455 illustrating timing of object highlighting in an ecommerce short-form video. A first temporal point of an ecommerce short-form video is indicated at 420. A first host individual 431 and a second host individual 433 are behind a countertop 417 on which a product 451 is placed. During the ecommerce short-form video, the speech 436 of host individual 431 and/or the speech 438 of host individual 433 is determined as being directed toward product 451. In some embodiments, when all host individuals within the ecommerce short-form video have mentioned the product, the product is then highlighted.

A second temporal point of the ecommerce short-form video is indicated at 421. The temporal point indicated by 421 is later than the temporal point indicated by 420. Thus, at some later point in the ecommerce short-form video, a highlight indication 430 for product 451 is rendered. In some embodiments, the highlight indication 430 is selectable by a viewer to obtain further information on the product 451, and/or to enable ecommerce purchase of the product 451. In some embodiments, the highlighting of the product is performed concurrently with rendering a product card corresponding to the product.

Some embodiments can rely solely on audio analysis to determine when/if to render a highlight indication for a product. These embodiments can be useful for ecommerce short-form videos where there is no on-screen host individual, but rather the voice of the host individual is presented as a voiceover audio track. Other embodiments can utilize a combination of eye gaze and audio analysis to determine when/if to render a highlight indication for a product.

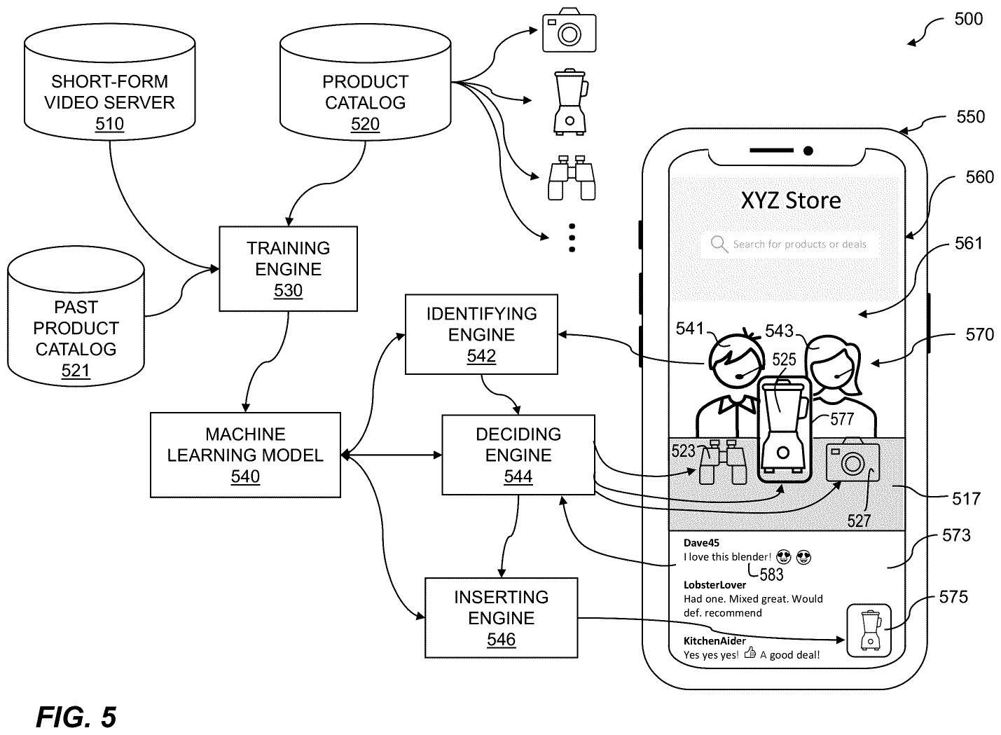

FIG. 5 is a block diagram 500 for machine model training and use. The block diagram 500 can include a short-form video server 510. The short-form video server can include a local server, a remote server, a cloud server, a distributed server, and so on. The short-form video server can deliver a short-form video from a plurality of short-form videos. The short-form videos stored on the server can be uploaded by individuals, content providers, influencers, tastemakers, and the like. The short-form videos on the server 510 can form a library of short-form videos. The short-form videos can include livestreams and livestream replays. In embodiments, the short-form video is obtained from a library of short-form videos.

The block diagram 500 can further include a product catalog 520. In embodiments, the product catalog 520 can be implemented as a database. The database can include a structured query language (SQL) database, or other suitable database type. The database can include products that are featured in one or more ecommerce short-form videos that are obtained from the short-form video server 510. In embodiments, the short-form video includes a livestream video or livestream video replay.

The block diagram 500 can further include a past product catalog 521. In embodiments, the past product catalog 521 can be implemented as a database. The database can include a structured query language (SQL) database, or other suitable database type. The past product catalog 521 can include products offered for sale in previous years, seasons, or other time periods. The past product catalogs can be useful for machine learning training purposes.

The block diagram 500 includes a training engine 530. The training engine 530 can include computer-implemented functions for ingest of training data used for supervised and/or semi-supervised machine learning. In embodiments, the product catalog 520 and past product catalog 521 contain multiple product images, along with associated metadata including product classifications, product manufacturers, and the like. The images and associated metadata can be processed by the training engine 530 to be in a format for training a machine learning model 540. The machine learning model 540 can include a support vector machine (SVM), convolutional neural network (CNN), multilayer perceptron, feed forward neural network, or other suitable neural network type.

The block diagram includes an electronic device 550. The electronic device includes an electronic display 560. Within the electronic display, an application 561 renders an ecommerce short-form video 570. The ecommerce short-form video 570 includes a first host individual 541 and a second host individual 543. The host individuals 541 and 543 are behind a countertop 517. On the countertop 517, three products, indicated as 523, 525, and 527 are shown.

The block diagram includes an identifying engine 542. The identifying engine 542 utilizes information from host individual 541 and/or host individual 543, such as eye gaze tracking, audio analyzing, and/or movements of the host individuals. The identifying engine identifies possible products currently being presented. A deciding engine 544 can receive a list of presented products from the identifying engine 542. The deciding engine can rank the list of products based on various criteria to determine which of the presented products is being discussed. As an example, if a camera, blender, and pair of binoculars are on a countertop in a short-form video, the deciding engine uses criteria to determine which of those products is currently being discussed/demonstrated in the short-form video. The criteria can include, but is not limited to, a host individual touching, holding, and/or moving an object; a host individual gazing at a product for a predetermined period; and/or a host individual discussing a product. Computer-implemented natural language processing techniques can be used to parse and analyze speech from the host individuals to determine which product is being discussed. In this example, since more than one product is presented concurrently within the ecommerce short-form video, the identifying engine 542 and deciding engine 544 are used to determine which product from among the multiple products being shown is under discussion at a given point in time.

The block diagram includes an inserting engine 546. The inserting engine can insert a product card 575 into the application 561. The product card 575 can be for the product being discussed as determined by the deciding engine 544. Product card 575 can be a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an additional on-screen display is rendered over a portion of the video while the video continues to play. This enables a user to purchase a product/service while preserving a continuous video playback session. In other words, the user is not redirected to another site or portal that causes the video playback to stop. Thus, users are able to initiate and complete a purchase completely inside of the video playback user interface without being directed away from the currently playing video. Allowing the video to play during the purchase can enable improved audience engagement, which can lead to additional sales and revenue, one of the key benefits of disclosed embodiments.

The application 561 can further include a chat window 573. The chat window can include comments and questions from viewers of the short-form video 570. This can enable additional engagement with the ecommerce short-form video. In some embodiments, the chat text within the chat window is used by the deciding engine 544 as part of the criteria for deciding which product of the multiple products should be highlighted with a highlight indication 577. As an example, one of the products disposed on countertop 517 is blender 525. Among the text in chat window 573 is the word “blender”, indicated at 583. The identification of words and/or phrases within the chat window 573 can be used to determine and/or confirm that the product currently under discussion is the blender 525, and not the camera 527 or binoculars 523. Thus, disclosed embodiments can improve the technical field of ecommerce short-form video analysis.

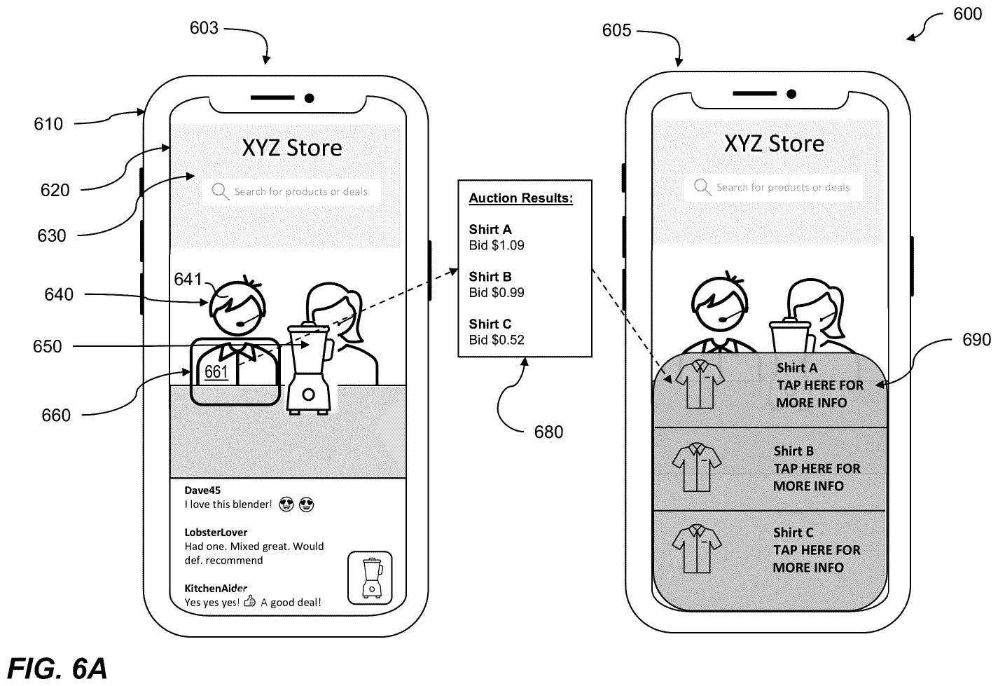

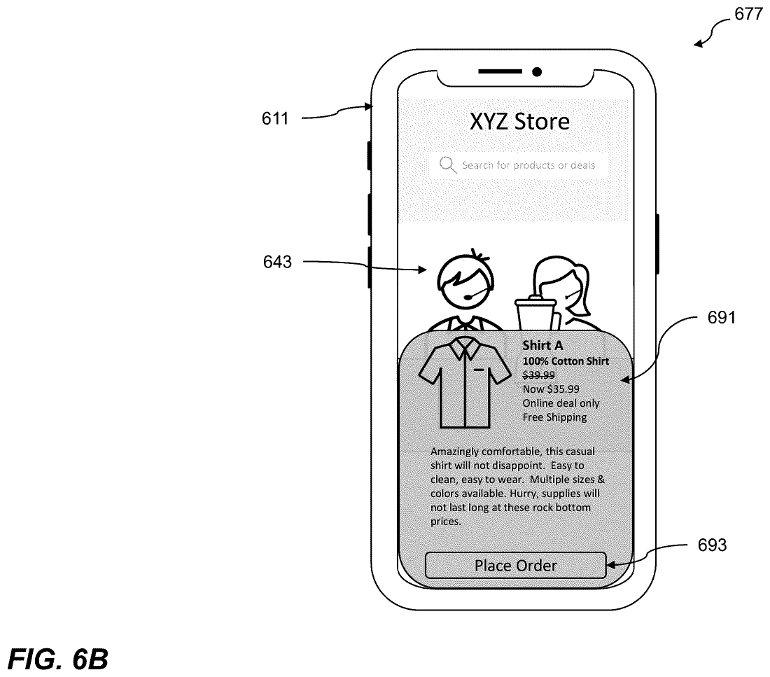

FIG. 6A is an infographic 600 showing real-time auction usage within an ecommerce short-form video. A first temporal point of ecommerce usage is indicated at 603, and a subsequent temporal point of ecommerce usage is indicated at 605. Electronic device 610 has an electronic display 620. In embodiments, electronic device 610 can include a smartphone, tablet computer, or other suitable electronic computing device. Electronic display 620 may include a touchscreen. An application 630 renders an ecommerce short-form video 640 on the display 620. The electronic device 610 can receive a region selection 660 from a user. The region selection can be performed by tapping, swiping, using a mouse cursor or stylus, or employing another suitable user interface technique. In this example, even though the product 650 being highlighted is a blender, the viewer of the video has provided a region selection 660 corresponding to a shirt 661 worn by host individual 641. Disclosed embodiments perform object recognition based on machine learning, determine that the object within the region selection 660 is a shirt, identify, based on pattern recognition techniques, the brand of shirt, and receive auction bids for various vendors that sell the shirt identified within region selection 660, and/or similar shirts. The auction results 680 are used to display a rendering 690 of one or more products for sale, listed in order of highest bid to lower bid as an overlay on the short-form video. In embodiments, the higher bids result in more prominent placement within the overlay.

FIG. 6B is an infographic 677 showing real-time auction usage within an ecommerce short-form video after making a selection. An expanded virtual product card 691 shows additional details for the product “Shirt A” while the ecommerce short-form video 643 continues to play on the electronic device 611. A button 693 within the expanded virtual product card 691 can enable ecommerce purchase of the product. In some embodiments, invoking the button 693 can perform an immediate purchase of the product, based on previously provided information such as payment information, shipping address, and the like. In some embodiments, invoking the button 693 can invoke additional user interfaces for entering payment and shipping information; selecting quantities, sizes, and colors of items; and/or other ecommerce functions.

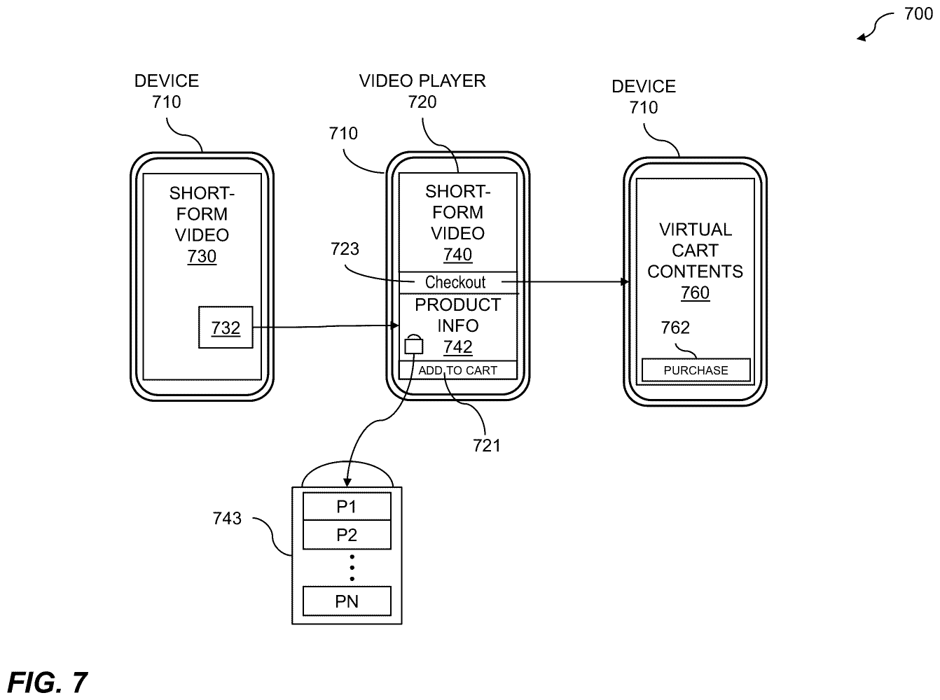

FIG. 7 is a system block diagram 700 illustrating virtual purchase cart operation. A user can view a video in which a product is introduced, promoted, endorsed, and so on. The user can choose to learn more about the product and if interested, can add the product to a shopping bag or cart in order to purchase the product. The user can learn about the product, can purchase the product, etc., without leaving the video that contains the product. Instead, the video can continue to play while the user is learning more about the product, purchasing the product, etc. The add-to-cart operation can be accomplished by clicking on an icon representing a virtual purchase cart or by interacting with the product within the video. The interacting can include tapping, clicking, swiping, mousing over or hovering, and the like. The add-to-cart operation enables ecommerce purchase within a short-form video environment. A short-form video, from a plurality of short-form videos delivered from a short-form video server, is rendered. A product within the short-form video is selected. The product within the short-form video is added to a virtual purchase cart based on the selecting. A representation of the virtual purchase cart is displayed, wherein the representation is visible while viewing the short-form video. In embodiments, the on-screen product card includes a picture, line drawing, icon, text, or emoji. In embodiments, the enabling further comprises revealing a virtual purchase cart. In embodiments, the enabling includes an ability for the user to update quantity, price, size, color, or other variable aspects of a product. Embodiments can further include completing checkout from the virtual purchase cart.

A device 710 can be used to display a short-form video 730. The device can include a hand-held electronic device, a portable electronic device, a desktop electronic device, and so on. In addition to the short-form video, a product card 732 can be rendered. The product card 732 that is rendered can be based on products that were highlighted based on actions of a host individual within the short-form video 730, and/or other criteria.

When the user selects (e.g., by tapping, clicking, etc.) the product card 732, an expanded product card 742 is rendered. The expanded product card can be overlaid on the short-form video 740 which continues to play in video player 720 on the device 710. The expanded product card 742 can include a virtual purchase card control 721. Invoking the virtual purchase card control 721 adds an entry in the virtual purchase cart 743. More than one product can be present in the virtual purchase cart 743. The virtual purchase cart 743 can include one or more products such as product P1, product P2, product PN and so on.

The expanded product card 742 can include a checkout control 723. Invoking the checkout control 723 causes the device 710 to render the virtual cart contents on the device 710. Virtual cart contents 760 can further include a purchase control 762. Invoking the purchase control 762 causes the electronic device 710 to enable an ecommerce purchase of the items corresponding to entries (P1−PN) in the virtual purchase cart 743.

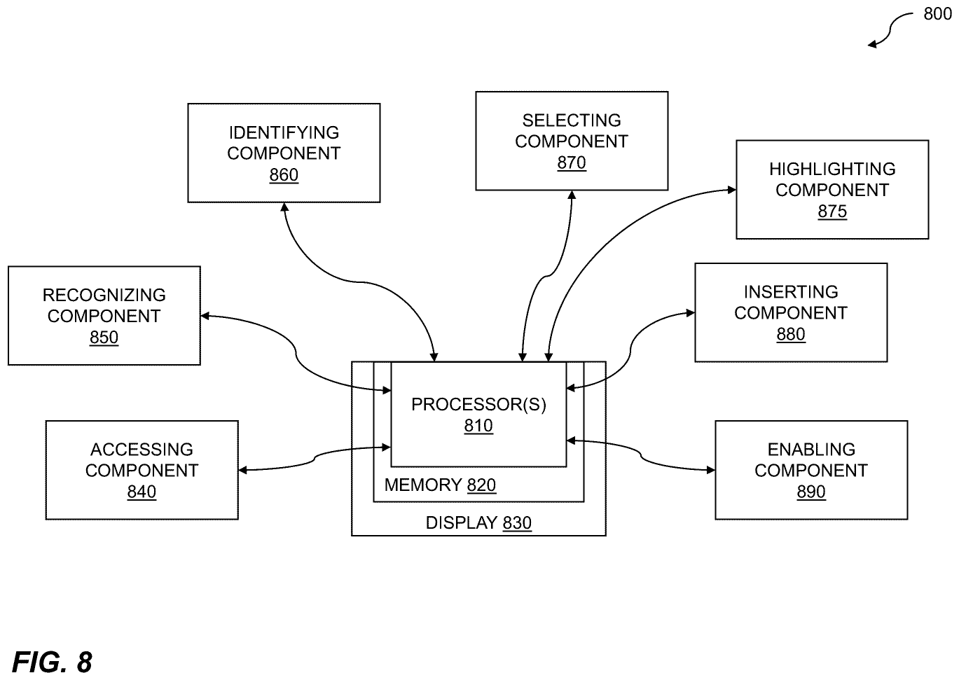

FIG. 8 is a system diagram for object highlighting in an ecommerce short-form video. The system 800 can include one or more processors 810 attached to a memory 820 which stores instructions. The system 800 can include a display 830 coupled to the one or more processors 810 for displaying data, video streams, videos, product information, virtual purchase cart contents, webpages, intermediate steps, instructions, and so on. In embodiments, one or more processors 810 are attached to the memory 820 where the one or more processors, when executing the instructions which are stored, are configured to: access a short-form video from a library of short-form videos; recognize a plurality of objects from a catalog of products featured in the short-form video; identify when a host is displaying at least one of the plurality of objects, based on the recognizing; select, using one or more processors, a first object from the plurality of objects, wherein the selecting is based on the identifying; highlight the first object in the short-form video, wherein the highlighting causes the first object to be surrounded by a boundary overlay in the short-form video; insert a representation of the first object into an on-screen product card, wherein the inserting is accomplished dynamically; and enable an ecommerce purchase of the first object, wherein the ecommerce purchase is accomplished within the short-form video.

The system 800 can include an accessing component 840. The accessing component 840 can include functions and instructions for accessing one or more ecommerce short-form videos. The short-form videos can include livestreams, and/or livestream replays. The accessing can include obtaining a uniform resource locator (URL) for a short-form video residing in a network-accessible library. The accessing can include initiating a playback session via HLS (HTTP Live Streaming), MPEG-DASH (Dynamic Adaptive Streaming over HTTP), WebRTC, RTSP (Real-Time Streaming Protocol), and/or other suitable protocols.

The system 800 can include a recognizing component 850. The recognizing component 850 can include functions and instructions for recognizing a plurality of objects from a catalog of products that are featured in the short-form video. The recognizing can be performed by training a machine learning system. The training can include using images of products and associated metadata to train one or more machine learning systems to identify products that may appear in an ecommerce short-form video. The training can also include natural language processing training to train a machine learning system on product names, product jargon, and the like.

The system 800 can include an identifying component 860. The identifying component 860 can include functions and instructions for identifying products and/or objects that appear in a short-form video. The identifying component 860 can include functions and instructions for extracting one or more still frames from a short-form video, and performing image processing techniques to identify one or more candidate regions that contain objects. The identification can be based on edge detection, gradient analysis, and can use various image classifiers. The images within the candidate regions can then be input to machine learning systems for the purposes of object identification.

The system 800 can include a selecting component 870. The selecting component 870 can include functions and instructions for deciding and selecting which object, amongst multiple objects being concurrently shown in a short-form video, is currently being discussed and/or demonstrated. This determination can be based on actions of one or more host individuals that are in the short-form video. The actions can include physical actions such as eye gaze toward the object, pointing to the object, gesturing toward the object, touching the object, picking up the object, holding the object, moving the object, and/or verbally mentioning the object.

The system 800 can include a highlighting component 875. The highlighting component 875 can include functions and instructions for rendering a highlight indication as an overlay overtop of a short-form video. The highlight indication can include a closed shape such as a rectangle, oval, or other shape. In embodiments, the highlighting component 875 retrieves the coordinates of a bounding box for an object within a video. This functionality can be obtained utilizing a computer vision library such as OpenCV, or the like. The coordinates of the bounding box can be used as input to a drawing function that draws the bounding box at the proper location within a viewport that is displaying the short-form video. If a host individual picks up an object or otherwise moves it, updated coordinates can be obtained from the computer vision library, and a new highlight indication can be rendered in the updated location, while any previous highlight indications are erased. In this way, the highlighted object remains highlighted, even as the object is moved. The highlighting can include a variety of shapes and colors, as well as other visual effects such as blinking, color shifting, overlay of animated graphics, and/or display of icons.

The system 800 can include an inserting component 880. The inserting component 880 can include functions and instructions for inserting a product card and/or other information related to the highlighted product. The inserting component 880 can insert a product card over a short-form video, while the short-form video continues to play. The inserting component 880 can also insert a product card over a non-video region within an application, such as over a chat window of an application that renders a short-form video.

The system 800 can include an enabling component 890. The enabling component 890 can include enabling an ecommerce purchase of a highlighted product, wherein the ecommerce purchase is accomplished within the short-form video and includes functions and instructions for revealing coupons, virtual purchase carts, and/or other information related to the highlighted product. The coupons can include QR codes, barcodes, alphanumeric codes, and the like. The virtual purchase carts can enable ecommerce purchase of one or more products that are shown and/or mentioned in an ecommerce short-form video.

These components of system 800 combine to enable enhanced interaction with ecommerce short-form videos. The system 800 can perform functions such as livestream event product setup. This can include crawling product catalogs to ingest images and associated descriptions, and training machine learning systems using the product catalog data. The product detection and training can be curated. Additionally, internet search engines can be used to search for additional related images. Embodiments can further include performing augmentation to enhance product angles. The augmentation can include various image transformations, including, but not limited to, shifts, flips, zooms, and more. The augmentation can further include lighting augmentation such as contrast and/or brightness adjustments. The augmentation can serve to expand the training data to enable more effective output from machine learning systems. The system 800 can further include the feature of performing text label extraction. This enables more accurate identification of products that include text labeling, images, barcodes, and/or other identifiers on packaging and/or labeling.

During a livestream broadcast, the system 800 can perform livestream video frame sampling. For one or more frames, a face angle model can be applied to determine if a host individual is facing toward a product for a predetermined time interval. Additionally, a gaze model can be applied to the frames to determine if the host individual is actually looking toward the product. The face angle and gaze models can be used to derive an estimated center of focus. Within the estimated center of focus, a focal point can be identified. Products that overlap in space with the focal point and/or center of focus can be selected as a highlightable product. Based on this information, along with identifying of product labels and product coordinates, objects of interest within the frame are detected and categorized. Metadata corresponding to the objects of interest can be embedded as metadata into the video stream frame. This facilitates an enhanced customer experience during livestream replays since the relevant metadata is already present within the livestream replay. When the metadata is encountered during a livestream replay, it can be used to trigger a real-time product highlight API, which can then initiate rendering of a highlight indication. In addition to the rendered highlight indication, an audio effect such as a chime sound can be mixed into the audio track of the short-form video. Thus, in embodiments, a sound effect is output concurrently with the rendering of the highlight indication. Additionally, an audio analysis model can be run on an audio track of the livestream broadcast to perform speech recognition and natural language processing, to determine when a given product is being discussed.

The system 800 can also receive input from viewers of ecommerce short-form videos, including a region selection. The region selection includes coordinates that specify a portion of a video frame. The contents of the video frame within the region can be analyzed using the machine learning systems. Objects within the region selection can be identified, and product information for the corresponding objects can be retrieved and presented in the form of product cards, coupons, and the like. This gives the unique advantage of promoting additional products that may not actually be the subject of the short-form video. As an example, if a host individual is wearing a nice shirt that generates interest from viewers, disclosed embodiments enable viewers of the short-form video to easily obtain more information about the shirt, and even purchase the shirt if desired. This can occur even if the host individual is demonstrating or discussing some other product unrelated to his/her shirt. In this way, previously untapped product promotion opportunities are realized, by virtue of the enhanced video analysis of disclosed embodiments.

The system 800 can include a computer program product embodied in a non-transitory computer readable medium for video analysis, the computer program product comprising code which causes one or more processors to perform operations of: accessing a short-form video from a library of short-form videos; recognizing a plurality of objects from a catalog of products featured in the short-form video; identifying when a host is displaying at least one of the plurality of objects, based on the recognizing; selecting, using one or more processors, a first object from the plurality of objects, wherein the selecting is based on the identifying; highlighting the first object in the short-form video, wherein the highlighting causes the first object to be surrounded by a boundary overlay in the short-form video; inserting a representation of the first object into an on-screen product card, wherein the inserting is accomplished dynamically; and enabling an ecommerce purchase of the first object, wherein the ecommerce purchase is accomplished within the short-form video.

The system 800 can include a computer system for video analysis comprising: a memory which stores instructions; one or more processors attached to the memory, wherein the one or more processors, when executing the instructions which are stored, are configured to: access a short-form video from a library of short-form videos; recognize a plurality of objects from a catalog of products featured in the short-form video; identify when a host is displaying at least one of the plurality of objects, based on the recognizing; select, using one or more processors, a first object from the plurality of objects, wherein the selecting is based on the identifying; highlight the first object in the short-form video, wherein the highlighting causes the first object to be surrounded by a boundary overlay in the short-form video; insert a representation of the first object into an on-screen product card, wherein the inserting is accomplished dynamically; and enable an ecommerce purchase of the first object, wherein the ecommerce purchase is accomplished within the short-form video.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video analysis comprising:
accessing a short-form video from a library of short-form videos;
recognizing a plurality of objects from a catalog of products featured in the short-form video;
identifying when a host is displaying at least one of the plurality of objects, based on the recognizing;
selecting, using one or more processors, a first object from the plurality of objects, wherein the selecting is based on the identifying;
highlighting the first object in the short-form video, wherein the highlighting causes the first object to be surrounded by a boundary overlay in the short-form video;
inserting a representation of the first object into an on-screen product card, wherein the inserting is accomplished dynamically; and
enabling an ecommerce purchase of the first object, wherein the ecommerce purchase is accomplished within the short-form video.

2. The method of claim 1 wherein the selecting is further based on audio analysis.

3. The method of claim 1 wherein the selecting is further based on gaze detection.

4. The method of claim 1 wherein the enabling further comprises revealing details of the first object based on a first user action with the on-screen product card or the boundary overlay.

5. The method of claim 1 further comprising training a machine learning model to recognize the plurality of objects from the catalog of products featured in the short-form video.

6. The method of claim 5 wherein the training includes images from past objects, product catalogs, short-form videos, keywords, or transfer learning.

7. The method of claim 5 wherein the training includes boosting or reducing weighting of images, wherein the boosting or reducing is based on the catalog of products.

8. The method of claim 5 wherein the training includes product categories that appear in the short-form video.

9. The method of claim 5 further comprising finding a second object from the plurality of objects.

10. The method of claim 9 wherein the highlighting includes the second object in the short-form video.

11. The method of claim 10 further comprising rendering one or more products for sale related to the second object, wherein the rendering is enabled by a second user action.

12. The method of claim 11 wherein the rendering one or more products for sale is based on a bid from an advertiser.

13. The method of claim 12 further comprising providing a bid suggestion, to the advertiser, based on effective cost per thousand impressions (eCPM).

14. The method of claim 12 wherein the rendering one or more products for sale is listed in order of highest bid to lower bid as an overlay on the short-form video.

15. The method of claim 3 wherein the gaze detection is accomplished with a cylindrical coordinate system.

16. The method of claim 15 wherein the gaze detection includes an angle of the host's face relative to the first object in the short-form video.

17. The method of claim 1 further comprising presenting a coupon overlay to a user.

18. The method of claim 17 wherein the coupon overlay is revealed to the user after watching the short-form video for a period of time.

19. The method of claim 17 wherein the presenting the coupon is based on metadata.

20. The method of claim 1 wherein the identifying is independent of physical motions of the host or location of the first object in the short-form video.

21. The method of claim 1 wherein metadata for the boundary overlay is recorded with the short-form video.

22. The method of claim 1 wherein the enabling further comprises revealing a virtual purchase cart.

23. The method of claim 22 wherein the enabling includes an ability for a user to clip coupons.

24. The method of claim 22 further comprising completing checkout from the virtual purchase cart.

25. A computer program product embodied in a non-transitory computer readable medium for video analysis, the computer program product comprising code which causes one or more processors to perform operations of:
accessing a short-form video from a library of short-form videos;
recognizing a plurality of objects from a catalog of products featured in the short-form video;
identifying when a host is displaying at least one of the plurality of objects, based on the recognizing;
selecting, using one or more processors, a first object from the plurality of objects, wherein the selecting is based on the identifying;
highlighting the first object in the short-form video, wherein the highlighting causes the first object to be surrounded by a boundary overlay in the short-form video;
inserting a representation of the first object into an on-screen product card, wherein the inserting is accomplished dynamically; and
enabling an ecommerce purchase of the first object, wherein the ecommerce purchase is accomplished within the short-form video.

26. A computer system for video analysis comprising:
a memory which stores instructions;
one or more processors attached to the memory wherein the one or more processors, when executing the instructions which are stored, are configured to:
access a short-form video from a library of short-form videos;
recognize a plurality of objects from a catalog of products featured in the short-form video;
identify when a host is displaying at least one of the plurality of objects, based on the recognizing;
select, using one or more processors, a first object from the plurality of objects, wherein the selecting is based on the identifying;
highlight the first object in the short-form video, wherein the highlighting causes the first object to be surrounded by a boundary overlay in the short-form video;
insert a representation of the first object into an on-screen product card, wherein the inserting is accomplished dynamically; and
enable an ecommerce purchase of the first object, wherein the ecommerce purchase is accomplished within the short-form video.
